(19) United States
(12) Patent Application Publication
(10) Pub. No.: US 2007/0047150 A1
(43) Pub. Date: Mar. 1, 2007

(54) Actuator and hard disk drive employing the same

(75) Inventors: Sung-kwon Choi, Seoul (KR); Min-pyo Hong, Suwon-si (KR); Cheol-soon Kim, Anyang-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/513,050

(22) Filed: Aug. 31, 2006

Related U.S. Application Data
(60) Provisional application No. 60/712,405, filed on Aug. 31, 2005.

(30) Foreign Application Priority Data
Aug. 31, 2005 (KR) 10-2005-0080619

(51) Int. Cl. G11B 5/48

(52) U.S. Cl. 360/246.6

(57) ABSTRACT

Provided are an actuator and a hard disk drive having the same. The actuator having a magnetic head and circularly movably mounted to move the head to a predetermined position on a disk, the actuator including: at least two arm members extending parallel to each other; a spacer interposed between and contacting the arm members to maintain a constant distance between the arm members and having a step portion to contact the arm members; a pivoting member inserted through throughholes respectively formed in the arm members and spacer, wherein the arm members and the spacer form a stack assembly and rotate around the pivot member; and a nut member screwed with the pivoting member at an end of the pivoting member and clamping the arm member and spacer with the pivoting member, wherein the step portion has a ring-shaped contact surface. In the actuator, the clamping deformation of a head stack assembly is prevented, thereby making it possible to accurately control the gap between a magnetic head and a recording side of the disk. Since the gap is constantly maintained, the head may not be damaged by external disturbance, thereby increasing product reliability.

### CROSS-REFERENCE TO RELATED PATENT APPLICATION

This application claims priority from Korean Patent Application No. 10-2005-0080619, filed on Aug. 31, 2005, in the Korean Intellectual Property Office, and U.S. Provisional Application No. 60/712,405, filed on Aug. 31, 2005, in the U.S. Patent and Trademark Office, the disclosures of which are incorporated herein in their entirety by reference.

### BACKGROUND OF THE INVENTION

1. Field of the Invention

Apparatuses consistent with the present invention relate to an actuator and a hard disk drive having the same and, more particularly, to an actuator having an improved structure which prevents the deformation of a head stack assembly supporting a head and a hard disk drive having the same.

2. Description of the Related Art

A hard disk drive is one of many information storage devices used in conjunction with a computer and may be used to record or reproduce information using a magnetic head. The hard disk includes an actuator where the magnetic head is mounted, which rotates above the disk to move the magnetic head to a predetermined position on the disk.

FIG. 1 is an exploded perspective view of an actuator 200 in the related art. The actuator 200 includes a first arm member 221, a second arm member 241 disposed under the first arm member 221, a spacer 230 interposed between the first arm member 221 and the second arm member 241, and a pivoting member 210 inserted in throughholes 221′, 230′, and 241′ formed in the arm members 221 and 241 and the spacer 230, respectively, all of which form a head stack assembly. A screw portion 215 having a shape matching an inner side of a nut member 253 is prepared at an end portion of the pivoting member 210. The screw portion 215 is then connected to the nut member 253. Accordingly, the arm members 221 and 241 are clamped on the pivoting member 210, that is, a flange portion 211 of the pivoting member 210, and the nut member 253. That is, the first arm member 221 is compressed between the flange portion 211 of the pivoting member 210 and the spacer 230. The second arm member 241 is compressed between the spacer 230 and the nut member 253. A washer 251 may be further interposed between the second arm member 241 and the nut member 253. A voice coil 237 coiled a predetermined number of times is supported on one side of the spacer 230. A magnet is disposed in a housing (not illustrated) and faces the voice coil 237. A controlled current flows through the voice coil 237 causing the actuator to rotate clockwise or counter-clockwise around the pivoting member 210 due to an interaction between a magnetic field generated by the voice coil 237 and a magnetic field of the magnet.

Meanwhile, the arm members 221 and 241, which receive a local clamping force from the flange portion 211 of the pivoting member 210 or the nut member 253, may be bent in a direction perpendicular to the longitudinal direction thereof or twisted. That is, the arm members 221 and 241 exhibit weak warpage resistance such that the magnetic head writing and reproducing data cannot maintain an optimized gap from the recording side of a disk, thereby degrading the data transfer rate or the accuracy of data. Moreover, if the gap between the magnetic head and the recording side of a disk is not appropriately secured, the magnetic head may directly impact the recording disk due to an unexpected vibration or disturbance such that the magnetic head and the recording disk are damaged, thereby deteriorating the reliability of the hard disk drive.

### SUMMARY OF THE INVENTION

The present invention provides an actuator having an improved structure which may prevent clamping deformation in a head stack assembly and, thus, may accurately control a gap between a head and a recording side of a disk, and a hard disk drive having the same.

According to an aspect of the present invention, there is provided an actuator having a magnetic head and movably mounted to move the head over a disk, the actuator including: two arm members which extend parallel to each other; a spacer interposed between the two arm members to maintain a distance between the two arm members and having a step portion to contact the two arm members; a pivoting member inserted through a throughhole formed in each of the two arm members and the spacer, wherein the two arm members and the spacer form a stack assembly and are adapted to rotate around the pivot member; and a nut member engaged with an end of the pivoting member and adapted to clamp the two arm members and the spacer with the pivoting member, wherein the step portion has a ring-shaped contact surface.

According to another aspect of the present invention, there is provided an actuator having a magnetic head and movably mounted to move the magnetic head over a disk, the actuator including: two arm members which extend parallel to each other; a spacer interposed between the two arm members to maintain a distance between the two arm members and having a step portion which protrudes to a predetermined height to contact the two arm members; a pivoting member inserted through a throughhole formed in each of the two arm members and the spacer, wherein the two arm members and the spacer form a stack assembly and are adapted to rotate around the pivot member; and a nut member engaged with an end of the pivoting member and adapted to clamp the two arm members and the spacer with the pivoting member, wherein an edge-cut portion is formed in at least a portion of an edge of the step portion.

According to another aspect of the present invention, there is provided an actuator having a magnetic head and movably mounted to move the magnetic head over a disk, the actuator including: two arm members which extend parallel to each other; a spacer interposed between the two arm members to maintain a distance between the two arm members and having a step portion to contact the two arm members; a pivoting member inserted through a throughhole formed in each of the two arm members and the spacer, wherein the arm members and the spacer form a stack assembly and are adapted to rotate around the pivot member; and a nut member engaged with an end of the pivoting member and adapted to clamp the two arm members and the spacer with the pivoting member, wherein the step portion is formed along the circumference surrounding the throughhole of the spacer.

According to another aspect of the present invention, there is provided a hard disk drive including a frame in which disk-shaped recording media are mounted and an actuator having a magnetic head and movably mounted in the frame to move the head over a disk, wherein the actuator includes: two arm members which extend parallel to each other; a spacer interposed between the two arm members to maintain a distance between the two arm members and having a step portion to contact the two arm members; a pivoting member inserted through a throughhole formed in each of the two arm members and the spacer, wherein the two arm members and the spacer form a stack assembly and are adapted to rotate around the pivot member; and a nut member engaged with an end of the pivoting member and adapted to clamp the two arm members and the spacer with the pivoting member, wherein the step portion has a ring-shaped contact surface.

According to another aspect of the present invention, there is provided a hard disk drive including a frame in which disk-shaped recording media are mounted and an actuator having a magnetic head and movably mounted in the frame to move the head over a disk, wherein the actuator includes: two arm members which extend parallel to each other; a spacer interposed between the two arm members to maintain a distance between the two arm members and having a step portion which protrudes to a predetermined height to contact the two arm members; a pivoting member inserted through a throughhole formed in each of the two arm members and the spacer, wherein the two arm members and the spacer form a stack assembly and are adapted to rotate around the pivot member; and a nut member engaged with an end of the pivoting member and adapted to clamp the two arm members and the spacer with the pivoting member, wherein an edge-cut portion is formed in at least a portion of an edge of the step portion.

### BRIEF DESCRIPTION OF THE DRAWINGS

The above and other features of the present invention will become more apparent by describing in detail exemplary embodiments thereof with reference to the attached drawings in which:

FIG. 1 is an exploded perspective view of a related art actuator.

FIG. 2 is a view illustrating a schematic structure of a hard disk drive according to an exemplary embodiment of the present invention;

FIG. 3 is an exploded perspective view illustrating a structure of an actuator of FIG. 2;

FIG. 4A is a view illustrating a layout of a flange portion according to an exemplary embodiment of the present invention;

FIG. 4B is a view illustrating another possible layout of a flange portion.

FIG. 5 is a cross-sectional view of the actuator of FIG. 3;

FIG. 6 is an enlarged cross-sectional view of a portion V in FIG. 5; and

FIGS. 7A and 7B are experimental results illustrating deformation amounts of the first and the second arm members, respectively.

### DETAILED DESCRIPTION OF THE EXEMPLARY EMBODIMENTS OF THE INVENTION

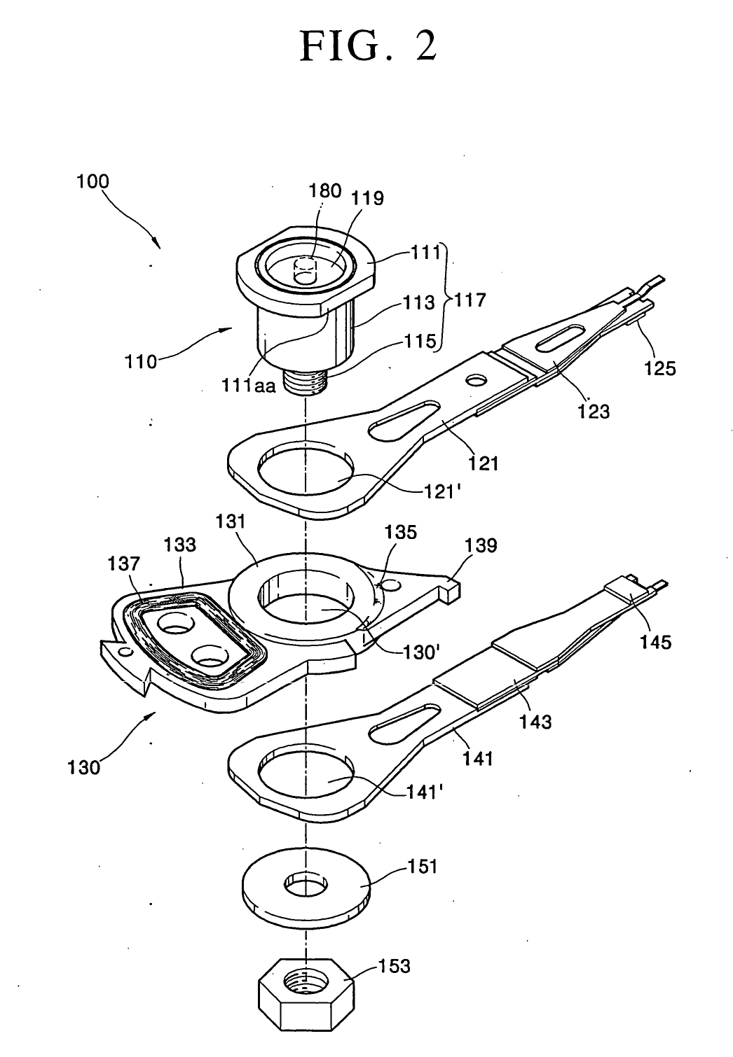

Hereinafter, an actuator and a hard disk drive employing the same according to exemplary embodiments of the present invention will be described more fully with reference to the accompanying drawings, in which exemplary embodiments of the invention are shown. FIG. 2 is a view illustrating a schematic structure of a hard disk drive 10 according to an exemplary embodiment of the present invention. The hard disk drive 10 includes a disk unit 20 having predetermined disks, i.e., recording media, a box shaped frame 11 where the disk unit 20 is accommodated, and a sealing member 13 sealing an upper portion of the frame 11. The disks in the disk unit 20 are rewritable, i.e., predetermined data can be rewritten or erased. A representative example of the disks is a magnetic disk where data is recorded using the magnetic characteristics thereof.

The disk unit 20 is mounted on a spindle motor 15 fixed on the frame 11, and rotates at high speed with the spindle motor 15. When a plurality of disks are installed according to the storage capacity of the hard disk drive 10, the plurality of disks are coaxially stacked on the spindle motor 15.

An actuator 100 is moved clockwise or counter-clockwise above the disk unit 20 rotated by the spindle motor 15. The actuator 100 is moved in approximately a radial direction of the disk unit 20 to access a target track on the disk unit 20 when writing data on or reading data from the disk unit 20. A magnetic head (not illustrated) is mounted at a tip-end portion of the actuator 100, facing a recording side of the disk unit 20. The magnetic head records/reproduces data and is located a fixed distance from the recoding side of the disk unit 20.

The actuator 100 is mounted to rotate around the pivot axis 180 protruding form a bottom surface of the frame 11. The actuator 100 moves above the disk in response to a driving signal transmitted from a flexible printed circuit 160 connected to the one side thereof, and moves away from the disk in response to a stopping signal transmitted from the flexible printed circuit 160. The flexible printed circuit 160 receives a control driving signal or electric power from a circuit substrate (not illustrated) disposed on a bottom of the frame 11. A bracket 161 installed in the comer of the frame 11 may be used to connect the flexible printed circuit 160 and the circuit substrate.

The actuator 100 includes a first arm member 121 disposed at a first side from the pivot axis 180, which is center of the rotation, and a voice coil 137 disposed at a second side. A suspension 123 extended in a longitudinal direction is attached to one end of the first arm member 121 and the magnetic head is attached to one end of the suspension 123. The magnetic head is elastically biased through the suspension 123 toward the recording side of the disk.

A voice coil 137 having a predetermined number of coils is supported at a second side of the actuator 100. A predetermined current is supplied to the voice coil 137 to induce a magnetic field the voice coil 137. A magnet 17 is fixed on the frame 11 facing the voice coil 137. As the magnet 17 and the voice coil 137 producing the induced magnetic field interact, the actuator 100 is rotated clockwise or counter-clockwise. The voice coil 137 and the magnet 17 form the main unit of the voice coil motor providing a driving force to the actuator 100. Although not illustrated, an additional magnet interacting with the voice coil 137 may be fixed on the upper cover 13, which faces the voice coil 137.

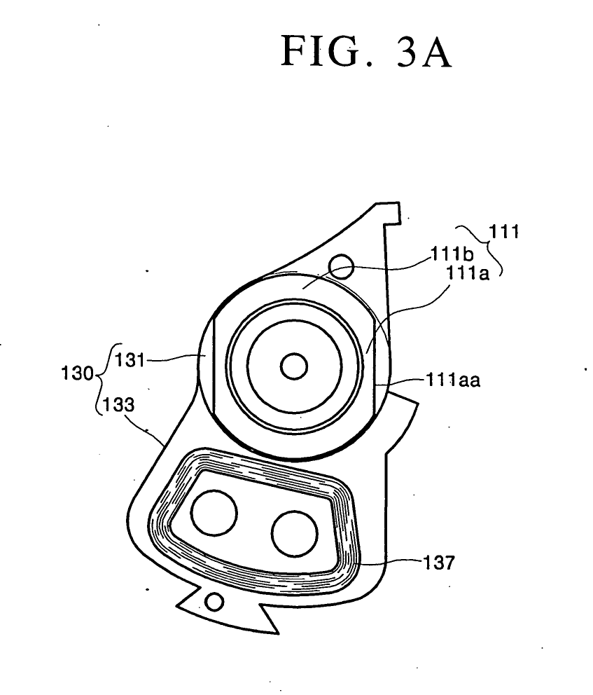

FIG. 3 is an exploded perspective view illustrating a structure of the actuator 100 of FIG. 2. The actuator 100 includes the first and the second arm members 121 and 141 and a spacer 130. The first and the second arm members 121 and 141 and the spacer 130 are compressed by a pivoting member 110, which is inserted through the first and the second arm members 121 and 141 and the spacer 130, and a nut member 153. The nut member 153 is screwed on the pivoting member 110. More specifically, the first and the second arm members 121 and 141 are apart from and parallel to each other. The spacer 130 is interposed between the first and the second arm members 121 and 141. The first and the second arm members 121 and 141 and the spacer 130 have throughholes 121′, 130′, and 141′, respectively, and the pivoting member 110 is inserted through the throughholes 121′, 130′, and 141′. The first and the second arm members 121 and 141 and the spacer 130 are arranged in order to align the throughholes 121′, 130′, and 141′.

The first and the second arm members 121 and 141 correspond to recording sides of a top surface and a rear surface of a disk, respectively. The number of the first and the second arm members 121 and 141 correspond to the number of disks in the hard disk drive.

The spacer 130 is interposed between the first and the second arm members 121 and 141 to maintain a distance therebetween. The spacer 130 has a thickness corresponding to the disk such that the first and the second arm members 121 and 141 can extend across the corresponding recording sides of the top surface and the rear surface of the disk, respectively. A step portion 131 is formed around the throughhole 130′ in the spacer 130 to contact and support the first and the second arm members 121 and 141, which will be described later. A coil supporter 133 is formed adjacent to the step portion 131. The coil supporter 133 supports the voice coil 137 in a groove having a predetermined depth. As discussed previously, the voice coil 137 provides a driving force to the actuator 100 by the interaction with the magnet installed in the frame 11.

The pivoting member 110 includes a hollow sleeve 117 surrounding the pivot axis 180 of the frame 111 at a predetermined radius, and a bearing member 119 interposed between the sleeve 117 and the pivot axis 180. Since the bearing member 119 is interposed between the sleeve 117 and the pivot axis 180, the head stack assembly simultaneously rotates with the sleeve 117 and can be supported and rotate around the pivot axis 180. The bearing member 119 may be any conventional bearing such as a ball bearing. The detailed descriptions of the structure and operation of the bearing member 119 will be omitted.

The sleeve 117 may have a multi-step structure. The structure includes a body portion 113 inserted in the throughholes 121′ and 141′ of the first and the second arm member 121 and 141, a flange portion 111 which has a large diameter and is formed at a top portion of the body portion 113, and a screw portion 115 which has a small diameter and is formed at a bottom portion of the body portion 113. The flange portion 111 protrudes from the outer circumference of the body portion 113 in a radial direction, and thus contacts the first arm member 121 surrounding the throughhole 121′ to provide a clamping force to the first arm member 121.

The screw portion 115 is formed in a side opposite the flange portion 111 and may have a smaller diameter than the body portion 113. A screw to contact the thread of the nut member 153 is formed on the outer circumference of the screw portion 115. The pivoting member 110 inserted through the first and the second arm members 121 and 141 is connected to the nut member 153 via the screw portion 115 such that the first and the second arm members 121 and 141 and the spacer 130 are assembled as a head stack assembly. In addition, a washer 151 may be interposed between the nut member 153 and the second arm member 141.

Thus, the head stack assembly may include the first and the second arm member 121 and 141 and the spacer 130 interposed between the pivoting member 110 and the nut member 153 connected with the screw portion 115. The first and the second arm member 121 and 141 and the spacer 130 between the pivoting member 110 and the nut member 153 are compressed by a clamping force provided by the flange portion 111 and the nut member 153. The first and the second arm members 121 and 141 and the spacer 130 have the circular throughholes 121′, 130′, and 141′, respectively, which have predetermined radii through which the pivoting member 110 may be inserted. The radii of the throughholes 121′, 130′, and 141′ are marginallyt smaller than the outer circumference of the sleeve 113 so that the sleeve 113 is forcedly inserted therethrough.

Suspensions 123 and 143 are longitudinally attached at front portions of the first and the second arm members 121 and 141, respectively. Sliders 125 and 145 facing the recording sides of the disk are attached at end portions of the suspensions 123 and 143, respectively. The sliders 125 and 145 are elastically biased by the suspensions 123 and 143 toward the recording sides of the disk, respectively. The slider 125 and 145 are each elastically supported by the suspensions 123 and 143, and float at a predetermined constant height from the disk as an upward force acting in a direction from the surface of the disk due to the rotation of the disk and an elastic force acting in a direction toward the disk by the suspension 123 and 143 balance each other.

Magnetic heads (not illustrated) reading and reproducing data are mounted on the sliders 125 and 145. The magnetic heads float at a predetermined height from the surface of the disk and magnetically interact with the disk. That is, the magnetic heads read the magnetically recorded data by the generation of an electrical signal corresponding to the magnetically recorded data or, alternatively magnetize a predetermined region of the disk via the electrical input signal to record data. A pair of magnetic heads parallel to each other face both surfaces of the disk according to the motion of the actuator to read recorded data or record data on the disk. A predetermined number of the first and the second arm member 121 and 141 correspond to the number of disks in the hard disk drive. For example, FIG. 3 shows the case of a single disk and two arm members each of which is prepared for different side of the disk.

A ring-shaped step portion 131 is formed in the spacer 130 and surrounds the circumference of the throughhole 130′ through which the pivoting member 110 is inserted. The step portion 131 may be formed at both sides of the spacer 130 facing the first and the second arm member 121 and 1 141. The step portion 131 protrudes a predetermined height to simultaneously contact the first and the second arm member 121 and 141. The step portion 131 is formed to have upward and downward steps from adjacent regions thereof, that is, from the edge member 139 protruded in an extending direction of the first and the second arm member 121 and 141 and from the coil supporter 133 formed opposite to the edge member 139.

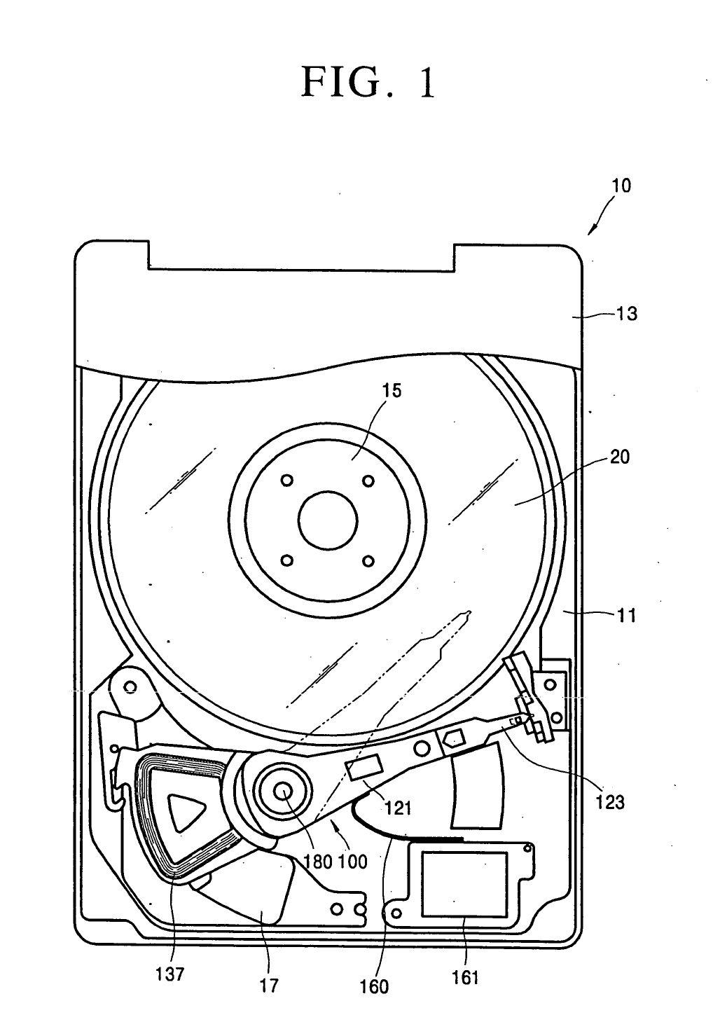

In the present exemplary embodiment, in order to prevent the first and the second arm member 121 and 141 from bending or twisting, the step portion 131 of the spacer 130 has a cylindrical shape, symmetrical with respect to the central axis of the pivoting member 110. That is, in the related art illustrated in FIG. 1, a step portion 231 is asymmetrical with respect to the central axis of the pivoting member 210 so that bending deformation of the first and the second arm member 221 and 241 may occur. In the present exemplary embodiment, since the step portion 131 has a cylindrical shape having an approximately constant width, the contact area of the step portion 131 with the first and the second arm member 121 and 141 has an approximately constant radius in all directions around the step portion 131. Accordingly, the deformation of the first and the second arm member 121 and 141 may be minimized. In FIG. 3, the step portion 131 has a circular ring-shape, but the present invention is not limited thereto. In consideration of the load distribution applied to the first and the second arm member 121 and 141, the step portion 131 may not have the circular ring-shape, but a shape of a variable radius.

Meanwhile, the flange portion 111 of the pivoting member 110 may have a cylindrical shape with a circular cross-section in order to clamp the first arm member 121 with a symmetrical uniform pressure with respect to the central axis of the pivoting member 110. More specifically, some portions of the flange portion 111 are cut to form a pair of cut sections 111aa having flat sides in the outer circumference thereof. The pair of cut sections 111aa are parallel to each other and are used for easily screwing the pivoting member 110. That is, in the assembly process of the actuator 100, the spacer 130 is inserted between the first and the second arm members 121 and 141, the pivoting member 110 is inserted through the throughholes 121′, 130′, and 141′, and then the pivoting member 110 is tightened with the nut member 153. At this time, a screw spanner having a shape corresponding to the cut sections 111aa of the pivoting member 110 can be used to grip the cut sections 111aa, and, thus, the pivoting member 110 can be easily screwed.

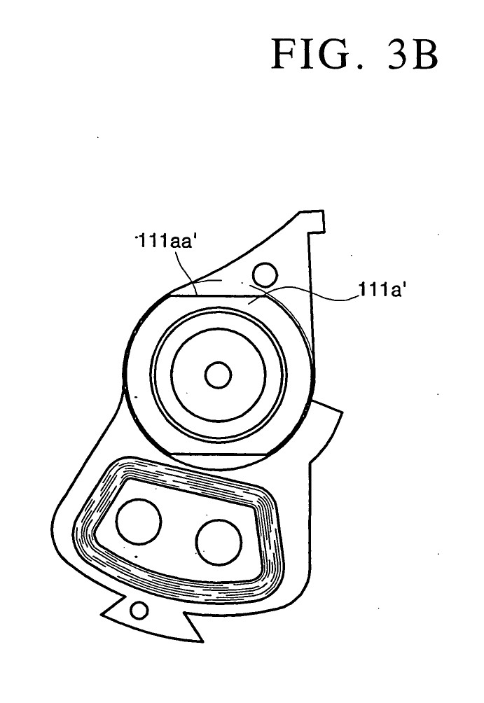

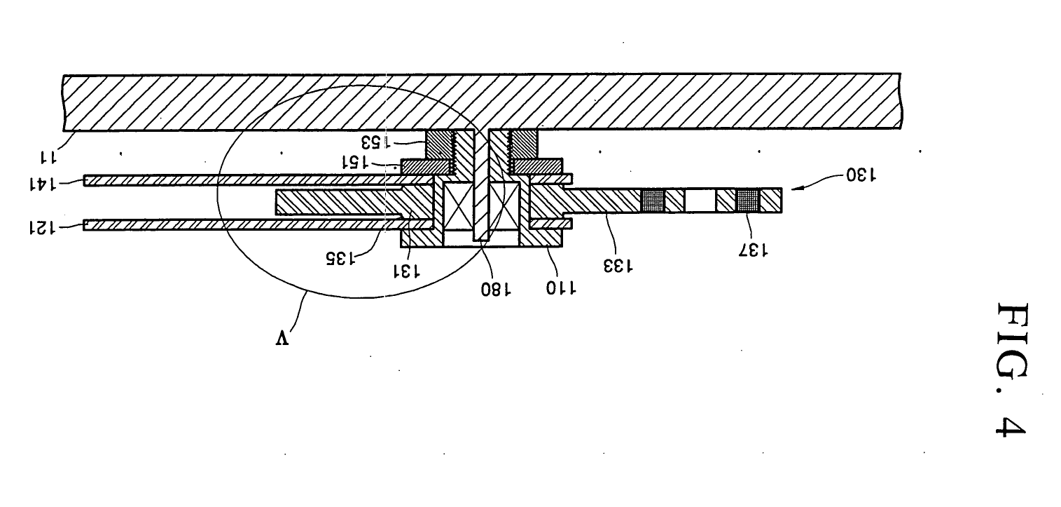

FIG. 4A is a view illustrating a layout of the flange portion 130, according to an exemplary embodiment of the present invention. FIG. 4B is a view illustrating another possible layout of a flange portion 130. In FIG. 4A, the pair of cut sections 111 aa facing each other are arranged to be approximately parallel to the extending direction of the first and the second arm members 121 and 141. Uncut portions 111b are approximately arranged in the longitudinal direction of the first and the second arm member 121 and 141, and the cut portions 11 la are approximately arranged along a direction perpendicular to the longitudinal direction of the first and the second arm member 121 and 141.

As described above, the pivoting member 110 is inserted through the stacked structure to clamp the first and the second arm member 121 and 141 and spacer 130 with the nut member 153. The first arm member 121 contacting the flange portion 111 of the pivoting member 110 receives a clamping force and tends to bend in an upward direction, which is the opposite direction of the clamping force. In the present exemplary embodiment, the uncut portions 111b having a relatively large contact surface are arranged in the longitudinal direction of the first and the second arm member 121 and 141 and press the first arm member 121, thereby preventing the first and the second arm member 121 and 141 from bending. However, in FIG. 4B, the cut portion 111a′ having the cut sections 111aa′ is arranged in the longitudinal direction of the first and the second arm member 121 and 141 such that the first and the second arm member 121 and 141 cannot be prevented from bending.

An edge-cut portion 135 is formed at an edge portion between the cylindrical outer circumference and the top side of the step portion 131 (See FIG. 3). Although not illustrated, another edge-cut portion may be formed at an edge portion between the cylindrical outer circumference and the bottom side of the step portion 131 to have the same shape of the edge-cut portion 135.

The edge-cut portion 135 may be formed along the entire edge between the cylindrical outer circumference and the top side of the step portion 131. Alternatively, the edge-cut portion 135 may be formed at a front side of the edge which is disposed in an extending direction of the first and the second arm member 121 and 141, as illustrated in FIG. 3. Since a symmetrical structure with respect to the extending direction of the first and the second arm members 121 and 141 may be sufficient to prevent warpage, edge-cut portions 135 may be formed to have similar shape at both right and left sides with respect to the longitudinal direction of the first and the second arm members 121 and 141. The edge-cut portions 135 can prevent the first and the second arm member 121 and 124 form bending, which will be described in detail.

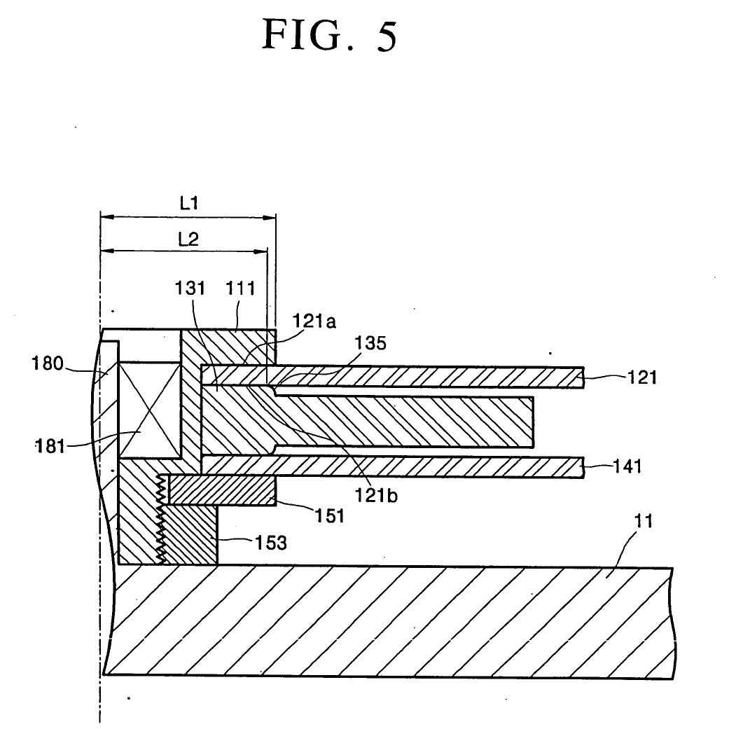

FIG. 5 is a cross-sectional view of the actuator 100 of FIG. 4. Referring to FIG. 5, local clamping forces are applied to the first and the second arm member 121 and 141 as the pivoting member 110 and the nut member 153 are pressed at back portions of the first and the second arm member 121 and 141, and repulsive forces are applied to the first and the second arm member 121 and 141 in opposite directions to the local clamping forces due to the step portion 131 supporting the first and the second arm member 121 and 141. Accordingly, the first and the second arm member 121 and 141 are upwardly and downwardly bent along the longitudinal direction thereof, respectively.

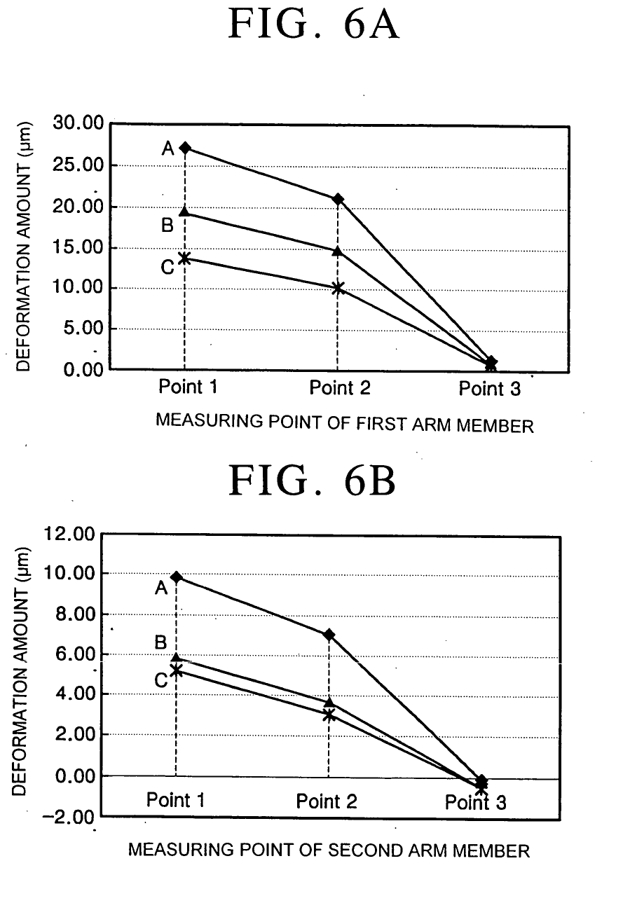

FIG. 6 is an enlarged cross-sectional view of portion VI in FIG. 5. Referring to FIG. 5, the first arm member 121 has in a portion of the top side thereof a first pressing plane 121a contacting a plane of the flange portion 111 of the pivoting member 110. The first arm member 121 has in a portion of the bottom side thereof a second pressing plane 121b contacting a plane of the an edge of the step portion 131 of the pivoting member 110. The edge-cut portion 135 is formed at the edge of the step portion 131 and, thus, the second pressing plane 121b has a smaller contact area than the first pressing plane 121a. That is, as illustrated in FIG. 6, a length L2 from the central axis of the pivoting member 110 to the end of the second pressing plane 121b is shorter than a length L1 from the central axis of the pivoting member 110 to the end of the first pressing plane 121a. Accordingly, the first and the second arm member 121 and 141 tend to bend toward the step portion 131 because the step portion 131 provides relatively less support. This bending force is opposite to the bending force caused by the local clamping and, thus, these bending forces offset each other. Therefore, the first and the second arm member 121 and 141 are at a horizontal level.

The edge-cut portion 135 may have a round shape having a predetermined curvature, as illustrated in FIG. 6, or an edge tapered shape for convenience of a manufacturing process, but the present invention is not limited thereto. In addition, the edge-cut portion 135 may be formed in any direction along the edge of the outer circumference of the step portion 131. For example, the edge-cut portion 135 may be formed at a front side of the first and the second arm member 121 and 141, as illustrated in FIG. 3, but may be formed at any position to satisfy an optimum condition to prevent the first and the second arm member 121 and 141 from bending.

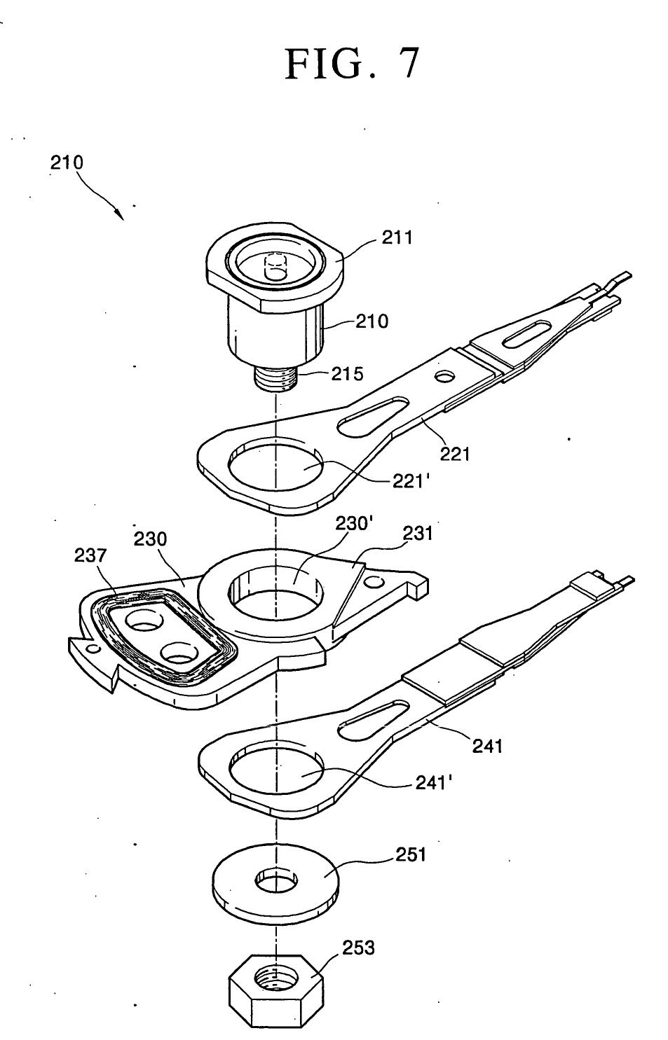

FIGS. 7A and 7B illustrate experimental results for confirming an effect of the present invention. FIGS. 7A and 7B show vertical displacements of the first and the second arm member 121 and 141. Lines A represents vertical displacements in the related art, line B represents vertical displacements according to an exemplary embodiment of the present invention when a cylindrical shaped step portion is formed in a spacer, and line C represents vertical displacements in another exemplary embodiment of the present invention when a cylindrical shaped step portion is formed in a spacer and an edge-cut portion is formed at an edge of the step portion

In FIGS. 7A and 7B, Point 1, Point 2, and Point 3 denote measuring points selected along the longitudinal direction of the first and the second arm member 121 and 141. Point 1 denotes a measuring point at the front end (a side near the suspension), Point 3 denotes a measuring point at the back end (a side near throughhole), and Point 2 denotes a measuring point from the front end to a predetermined distance between Point 1 and Point 3.

The vertical displacement is defined as a vertical distance by which the first or second arm member 121 or 141 moves due to the deformation with respect to a horizontal reference line. When the first arm 121 is upwardly bent, the vertical displacement of the first arm 121 is positive (+), and when the second arm member 141 is downwardly bent, the vertical displacement of the second arm 141 is positive (+).

The vertical deformation of the first and the second arm members 121 and 141 increase from the back end to the front end thereof, and thereby the first arm member 121 is upwardly bent and the second arm member 141 is downwardly bent in all cases. However, the difference in vertical deformation between the maximum deformation and the minimum deformation, that is, the deformation of the first and the second arm member 121 and 141 according to the exemplary embodiments of the present invention is smaller than that in the related art. This indicates that in the present invention, the first and the second arm member 121 and 141 bend less. Therefore, the formations of the cylindrical shaped step portion and the edge-cut portion improve the performance of the actuator.

According to the actuator and the hard disk drive having the same according to the exemplary embodiments of the present invention, bending deformation of a head stack assembly in the actuator may be prevented, thereby making it possible to accurately control the gap between a magnetic head supported by the head stack assembly and a recording side of the disk. Accordingly, the rate and accuracy for transferring data may be improved. Since the gap is constantly maintained, the head may not be damaged by external disturbance, thereby increasing product reliability. In addition, the accurate control of the clamping force for the pivoting member is not necessary to prevent deformation in the head stack assembly process. Therefore, the assembly process becomes easy and fast.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An actuator having a head and circularly movably mounted to move the head to a predetermined position on a disk, the actuator comprising:
at least two arm members extending parallel to each other;
a spacer interposed between and contacting the arm members to maintain a constant distance between the arm members and having a step portion to contact the arm members;
a pivoting member inserted through throughholes respectively formed in the arm members and spacer, wherein the arm members and the spacer form a stack assembly and rotate around the pivot member; and
a nut member screwed with the pivoting member at an end of the pivoting member and clamping the arm member and spacer with the pivoting member,
wherein the step portion has a ring-shaped contact surface.

2. The actuator of claim 1, wherein the step portion is formed along the circumference surrounding the throughhole.

3. The actuator of claim 2, wherein a width of the contact surface of the step portion varies along the circumference of the throughhole.

4. The actuator of claim 1, wherein the step portion protruues to a predetermined height to contact the arm member to simultaneously contact the arm members.

5. The actuator of claim 1, wherein an edge-cut portion is formed in at least a portion of an edge on the outer circumference of the step portion.

6. The actuator of claim 5, wherein the edge-cut portion has an edge tapered shape.

7. The actuator of claim 5, wherein the edge-cut portion has a round shape having a predetermined curvature.

8. The actuator of claim 5, wherein the edge-cut portion is formed at a front side in which the arm member extends.

9. The actuator of claim 1, wherein the pivoting member comprises:
a body portion inserted through the throughholes; and
a flange portion protruding from the body portion in a radial direction and providing a clamping force the arm members.

10. The actuator of claim 9, wherein the flange portion has at least one cut disk shape having a flat lateral plane.

11. The actuator of claim 10, wherein the flange portion comprises a cut portion having a flat lateral plane and an uncut portion having a round lateral plane, and the uncut portion is arranged along the longitudinal direction of the arm member.

12. The actuator of claim 10, wherein the flange portion comprises two flat lateral planes parallel to each other.

13. The actuator of claim 9, wherein the arm member is pressed between the flange portion of the pivoting member and the step portion of the spacer and comprises a first pressing plane contacting a plane of the flange portion and a second pressing plane contacting a plane of the step portion, and the area of the first pressing plane is larger than that of the second pressing plane.

14. The actuator of claim 13, wherein a length between the central axis of the pivot member and the end of the first pressing plane is longer than a length between the central axis of the pivot member and the end of the second pressing plane along the longitudinal direction of the arm member.

15. The actuator of claim 1, wherein a coil supporter, which supports a voice coil coiled a predetermined number of times is placed adjacent to the step portion.

16. An actuator having a magnetic head and circularly movably mounted to move the magnetic head to a predetermined position on a disk, the actuator comprising:
at least two arm members extending parallel to each other;
a spacer interposed between and contacting the arm members to maintain a constant distance between the arm members and having a step portion which protruded to a predetermined height to contact the arm members;
a pivoting member inserted through throughholes respectively formed in the arm members and spacer, wherein the arm members and the spacer form a stack assembly and rotate around the pivot member; and
a nut member screwed with the pivoting member at an end of the pivoting member and clamping the arm member and spacer with the pivoting member,
wherein an edge-cut portion is formed in at least a portion of an edge of the step portion.

17. The actuator of claim 16, wherein the step portion is formed along the circumference surrounding the throughhole and the edge-cut portion is formed in at least a portion of an edge on the outer circumference of the step portion.

18. The actuator of claim 16, wherein the edge-cut portion is formed at a front side in which the arm member extends.

19. The actuator of claim 16, wherein the edge-cut portion has an edge tapered shape or a round shape having a predetermined curvature.

20. An actuator having a magnetic head and circularly movably mounted to move the magnetic head to a predetermined position on a disk, the actuator comprising:
at least two arm members extending parallel to each other;
a spacer interposed between and contacting the arm members to maintain a constant distance between the arm members and having a step portion to contact the arm members;
a pivoting member inserted through throughholes respectively formed in the arm members and spacer, wherein the arm members and the spacer form a stack assembly and rotate around the pivot member; and
a nut member screwed with the pivoting member at an end of the pivoting member and clamping the arm member and spacer with the pivoting member, wherein the step portion is formed along the circumference surrounding the throughhole.

21. The actuator of claim 20, wherein the step portion comprises a ring-shaped contact surface having a variable width along the circumference of the throughhole.

22. A hard disk drive comprising a frame in which disk-shaped recording media are mounted and an actuator having a magnetic head and circularly movably mounted in the frame to move the head to a predetermined position on a disk, wherein the actuator comprises:
at least two arm members extending parallel to each other;
a spacer interposed between and contacting the arm members to maintain a constant distance between the arm members and having a step portion to contact the arm members;
a pivoting member inserted through throughholes respectively formed in the arm members and spacer, wherein the arm members and the spacer form a stack assembly and rotate around the pivot member; and
a nut member screwed with the pivoting member at an end of the pivoting member and clamping the arm member and spacer with the pivoting member,
wherein the step portion has a ring-shaped contact surface.

23. A hard disk drive comprising a frame in which disk-shaped recording media are mounted and an actuator having a magnetic head and circularly movably mounted in the frame to move the head to a predetermined position on a disk, wherein the actuator comprises:
at least two arm members extending parallel to each other;
a spacer interposed between and contacting the arm members to maintain a constant distance between the arm members and having a step portion which protrudes to a predetermined height to contact the arm members;
a pivoting member inserted through throughholes respectively formed in the arm members and spacer, wherein the arm members and the spacer form a stack assembly and rotate around the pivot member; and
a nut member screwed with the pivoting member at an end of the pivoting member and clamping the arm member and spacer with the pivoting member,
wherein an edge-cut portion is formed in at least a portion of an edge of the step portion.
